(19) United States
(12) Patent Application Publication
(10) Pub. No.: US 2010/0149181 A1
(43) Pub. Date: Jun. 17, 2010

(54) VECTOR GRAPHICS SYSTEM AND VECTOR GRAPHICS RENDERING METHOD

(75) Inventors: Huai-Che Lee, Taipei County (TW); Chia-Wei Liao, Taipei City (TW); Zong-Hong Lyu, Nantou County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INSTITUTE FOR INFORMATION INDUSTRY, Taipei (TW)

(21) Appl. No.: 12/344,827

(22) Filed: Dec. 29, 2008

(30) Foreign Application Priority Data
Dec. 12, 2008 (TW) 97148501

(51) Int. Cl. G06T 17/20

(52) U.S. Cl. 345/423

(57) ABSTRACT

The invention provides a vector graphics system. In one embodiment, the vector graphics system comprises a path rendering manager module and a rendering module. The path rendering manager module receives path data, calculates a changing rate of the path data, and selects a filling method from a tessellation filling method and a Stencil filling method according to the changing rate. The rendering module fills the path data according to the tessellation filling method when the filling method is the tessellation filling method, and fills the path data according to the Stencil filling method when the filling method is the Stencil filling method.

### BACKGROUND OF THE INVENTION

1. Field of the Invention

The invention relates to vector graphics rendering, and more particularly to path data filling of vector graphics rendering.

2. Description of the Related Art

Raster graphics records pixel colors of a picture. On the contrary, vector graphics records geometrical outlines of a picture. Geometrical outlines of pictures rendered in vector graphics are stored as path data. Before the pictures rendered in vector graphics are displayed on a screen, raw path data of the pictures must be processed by a flattening process and a filling process. The flattening process samples the path data to obtain vertexes forming the outlines of the path data. A filling process fills the surface areas defined by the vertexes with pixel colors, thus obtaining the pictures to be shown on the screen.

A tessellation filling method and a Stencil filling method are alternatively used in a filling process for filling path data. Referring to FIG. 1A, a schematic diagram of filling of path data according to a tessellation filling method is shown. Path data shown in FIG. 1A comprises 7 vertexes P1˜P7. Edges L1˜L7 defined by the vertexes P1˜P7, divides the picture into two an exterior area A1 and an interior area A2. Assume that the exterior area A1 needs to be filled and the interior area A2 does not need to be filled. When a tessellation filling process is performed, the path data is first divided into multiple triangle regions A₁₁˜A₁₄ and A₂ defined by the vertexes P1˜P7, and the triangle regions A₁₁˜A₁₄ and A₂ are then filled with color pixels, wherein the triangle regions A₁₁˜A₁₄ and A₂ are referred to as mesh data. Generation of the mesh data A₁₁˜A₁₄ and A₂ requires a great amount of computational load of a central processing unit (CPU). Meanwhile, because the triangle regions A₁₁˜A₁₄ and A₂ of mesh data do not overlap, color filling of the mesh data has high efficiency.

Referring to FIG. 1B, a schematic diagram of filling of path data according to a Stencil filling method is shown. Path data shown in FIG. 1B comprises vertexes P1˜P4. When the Stencil filling process is performed, the Stencil filling process does not need mesh data and can be performed directly according to the vertex data P1˜P4. Vertexes P1, P2, and P3 and vertexes P1, P4, and P3 respectively form the filling area. A Stencil buffer is used to record an overlapped region (−) of the filling area P1-P2-P3 and P1-P4-P3, and the Stencil filling process fills the filling area P1-P2-P3 and P1-P4-P3 except for the overlapped region (−). Although the Stencil filling process does not require generation of mesh data, a graphic processing unit (GPU) repeats color filling of an overlapped region according to the Stencil filling method, thereby lowering efficiency of the entire filling process.

Referring to FIGS. 2A and 2B, computational loads of a center processing unit (CPU) and a graphics processing unit (GPU) for performing a tessellation filling process and a Stencil filling process are respectively shown. For the tessellation filling process, a request is made to the CPU to generate mesh data according to path data. When path data is static or the path data has a low changing rate, the mesh data can be generated at a low frequency, reducing computational load of the CPU. Therefore, a tessellation filling method is suitable for filling path data with a lower changing rate. On the contrary, a Stencil filling process directly performs color filling according to vertex data and does not require mesh data conversion, thus reducing computational load of the CPU. Therefore, a Stencil filling method is suitable for filling path data with a higher changing rate.

Although the tessellation filling method and the Stencil filling method is suitable for different types of path data, a conventional vector graphics system cannot dynamically select different filling methods for filling different path data of a picture. Thus, when a picture comprises both path data with a low changing rate and path data with a high changing rate, a conventional vector graphics system fills the low changing rate path data or the high changing rate path data with low efficiency, degrading performance of the vector graphics system. In addition, when a changing rate of the path data changes, a conventional vector graphics system cannot correspondingly change the filling method according to the changing rate of the path data. Furthermore, a conventional vector graphics system does not evaluate in advance, whether a Stencil buffer bit depth required by a Stencil filling process is feasible. A new vector graphics rendering method is therefore provided.

### BRIEF SUMMARY OF THE INVENTION

The invention provides a vector graphics system. In one embodiment, the vector graphics system comprises a path rendering manager module and a rendering module. The path rendering manager module receives path data, calculates a changing rate of the path data, and selects a filling method from a tessellation filling method and a Stencil filling method according to the changing rate. The rendering module fills the path data according to the tessellation filling method when the filling method is the tessellation filling method, and fills the path data according to the Stencil filling method when the filling method is the Stencil filling method.

The invention provides a vector graphics rendering method. First, path data is received. A changing rate of the path data is then calculated. The changing rate is then compared with a threshold value. When the changing rate is greater than the threshold value, a Stencil filling method is selected as a filling method. When the changing rate is less than the threshold value, a tessellation filling method is selected as the filling method. The path data is then filled according to the filling method.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a schematic diagram of filling of path data according to a tessellation filling method;

FIG. 1B is a schematic diagram of filling of path data according to a Stencil filling method;

FIG. 2A shows computational loads of a center processing unit (CPU) and a graphics processing unit (GPU) for performing a tessellation filling process;

FIG. 2B shows computational loads of a center processing unit (CPU) and a graphics processing unit (GPU) for performing a Stencil filling process;

FIG. 3 is a block diagram of a vector graphics system according to the invention;

FIG. 4 is a block diagram of a path rendering manager module according to the invention;

FIG. 5 is a flowchart of a vector graphics rendering method according to the invention;

FIG. 6 is a schematic diagram of an embodiment of calculation of a changing rate of path data according to the invention;

FIG. 7A is a schematic diagram of an embodiment of filling of animation path data according to the invention; and

FIG. 7B is a schematic diagram of an embodiment of filling of button path data according to the invention.

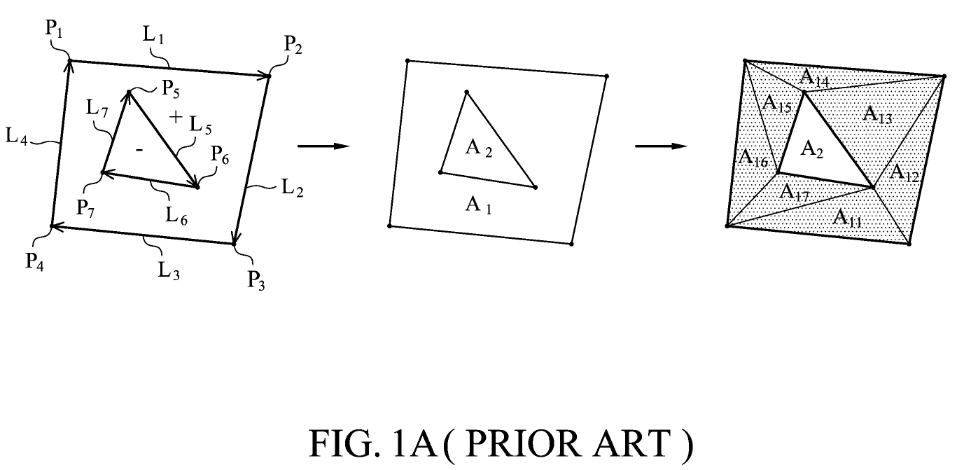

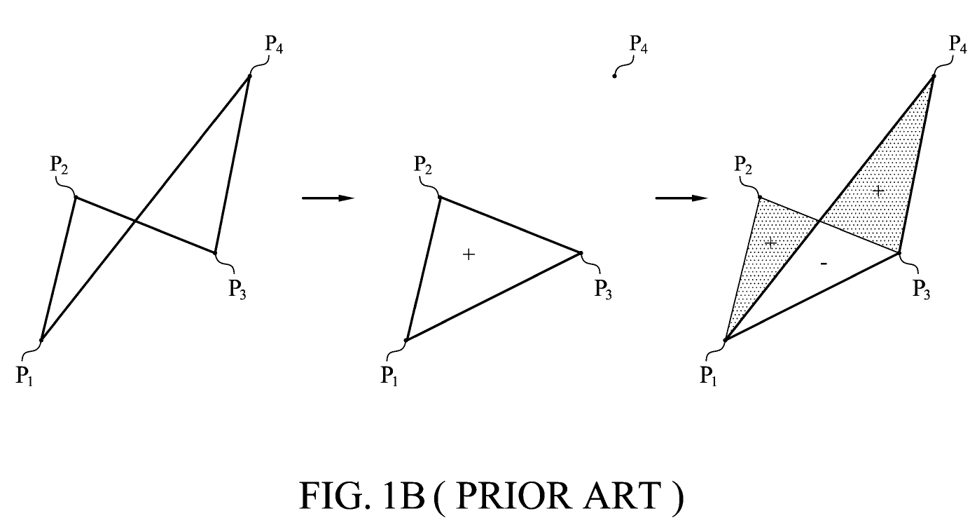

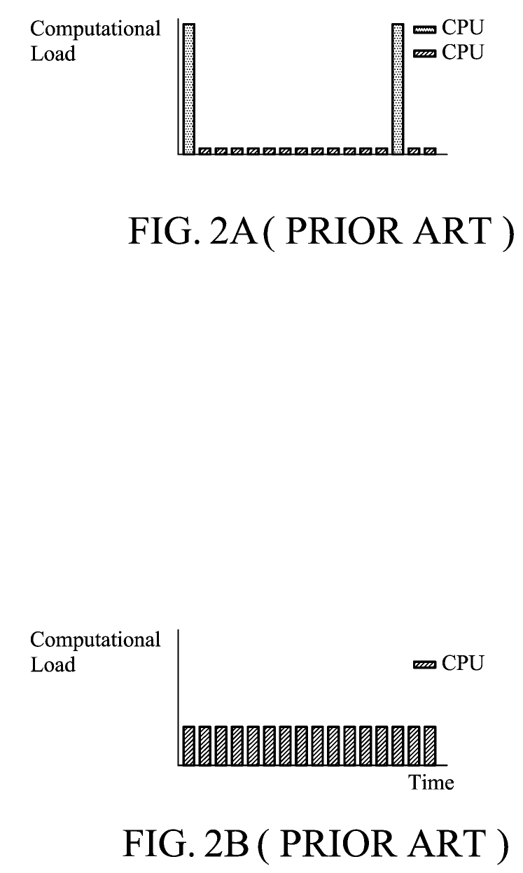

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

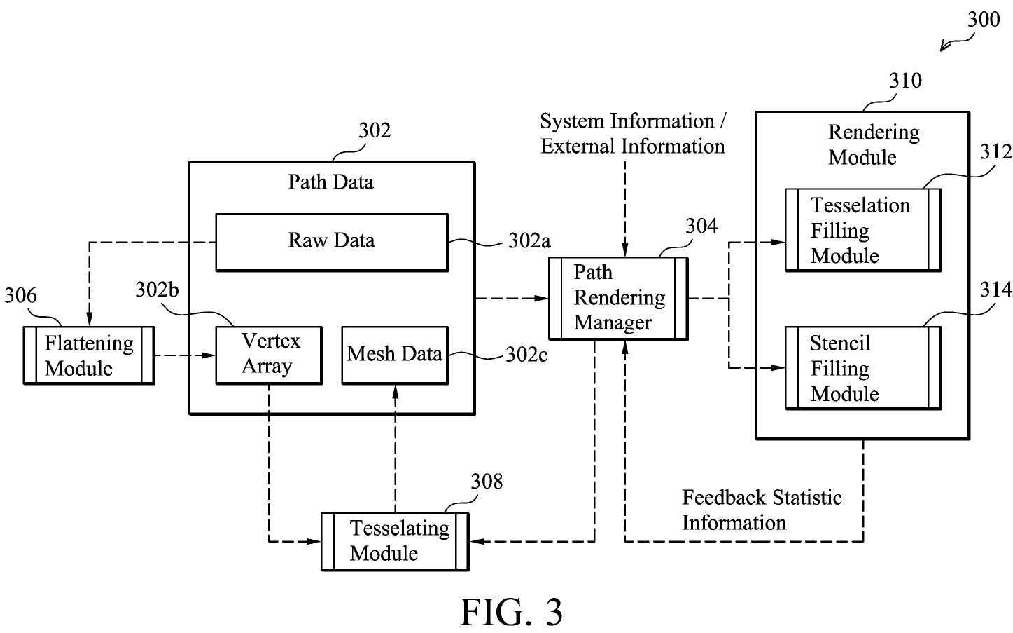

Referring to FIG. 3, a block diagram of a vector graphics system 300 according to the invention is shown. The vector graphics system 300 can dynamically use different filling methods for filling path data according to changing rates of the path data. In one embodiment, the vector graphics system 300 comprises a path rendering manager module 304, a flattening module 306, a tessellating module 308, and a rendering module 310. The vector graphics system 300 first receives raw data 302a of path data 302. The flattening module 306 then performs a flattening process on the raw data 302a to obtain vertex array data 302b. The path rendering manager module 304 then calculates a changing rate of the path data 302. In one embodiment, the path rendering manager module 304 calculates the changing rate of the path data 302 according to feedback statistic information generated by the rendering module 310. The path rendering manager module 304 then selects a filling method for filling the path data 302 from a tessellation filling method and a stencil filling method according to the changing rate.

In one embodiment, the path rendering manager module 304 compares the changing rate of the path data 302 with a threshold value. When the changing rate is greater than the threshold value, the path rendering manager module 304 selects the Stencil filling method as the filling method, and directs the rendering module 310 to fill the path data 302 according to the Stencil filling method. When the changing rate is less than the threshold value, the path rendering manager module 304 selects the tessellation filling method as the filling method, and directs the rendering module 310 to fill the path data 302 according to the tessellation filling method. The filling method for filling the path data 302 is therefore dynamically changed according to the change rate of the path data 302, wherein path data 302 with a low changing rate is filled according to the tessellation filling method, and path data 302 with a high changing rate is filled according to the Stencil filling method. Thus, efficiency of filling of the path data 302 is increased, and performance of the vector graphics system 300 is improved.

The rendering module 310 comprises a tessellation filling module 312 and a Stencil filling module 314. When the path rendering manager module 304 selects the Stencil filling method, the path rendering manager module 304 delivers a vertex array 302b of the path data 302 to the Stencil filling module 314. The Stencil filling module 314 then fills the vertex array 302b according to the Stencil filling method. When the path rendering manager module 304 selects the tessellation filling method, the path rendering manager module 304 directs the tessellating module 308 to convert the vertex array 302b to mesh data 302c, and then delivers the mesh data 302c of the path data 302 to the tessellation filling module 312. The tessellation filling module 312 then fills the mesh data 302c according to the tessellation filling method.

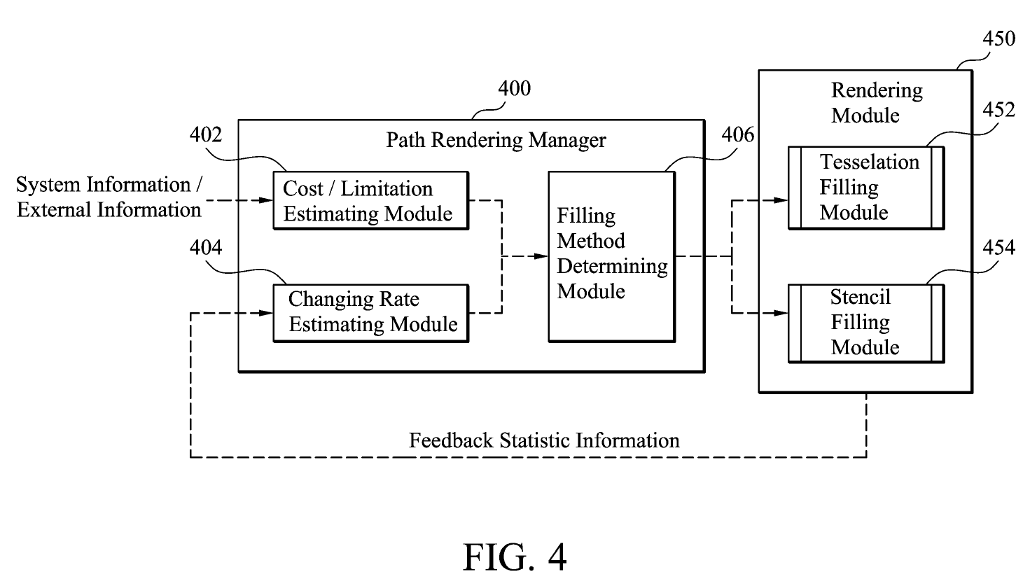

Referring to FIG. 4, a block diagram of a path rendering manager module 400 according to the invention is shown. In one embodiment, the path rendering manager module 400 comprises a cost/limitation estimating module 402, a changing rate estimating module 404, and a filling method determining module 406. In one embodiment, the changing rate estimating module 404 estimates a changing rate of a path data according to feedback statistic information generated by a rendering module 450. The filling method determining module 406 then selects a filling method from a Stencil filling method and a tessellation filling method according to the changing rate estimated by the changing rate estimating module 404. In addition, the filling method determining module 406 adjusts the filling method according to attributes of the path data. For example, when the path data is read-only data, the path data is inferred to be static path data and the rendering module 450 is directed to fill the path data according to a tessellation filling method.

In one embodiment, the cost/limitation estimating module 402 estimates computational loads required by a tessellation filling method and a Stencil filling method for processing path data, and then analyze whether the vector graphics system 300 can provide the computational loads required by the tessellation filling method and the Stencil filling method according to system information of the vector graphics system 300. The filling method determining module 406 can then determine the filling method according to the analysis result obtained by the cost/limitation estimating module 402. In another embodiment, the cost/limitation estimation module 402 also estimates a Stencil buffer bit depth required by the Stencil filling method for processing path data, and analyze whether the vector graphics system 300 can provide the Stencil buffer bit depth, according to system information of the vector graphics system 300. The filling method determining module 406 can then determine the filling method according to the analysis result obtained by the cost/limitation estimating module 402.

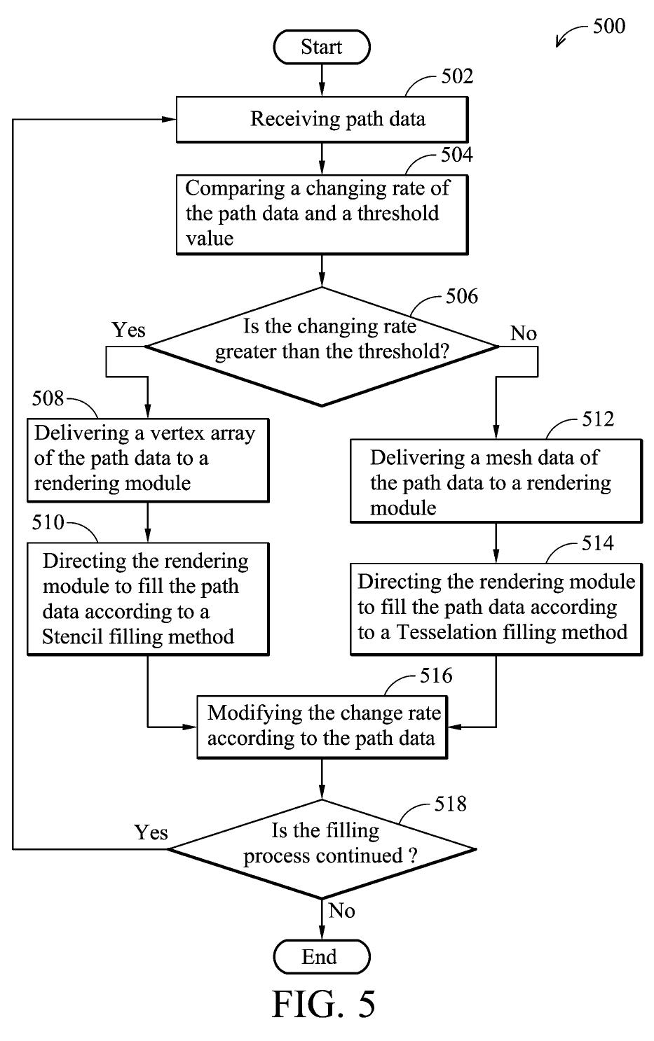

Referring to FIG. 5, a flowchart of a vector graphics rendering method 500 according to the invention is shown. First, path data is received (step 502). A changing rate of the path data is then compared with a threshold value (step 504). When the changing rate of the path data is greater than the threshold (step 506), a vertex array of the path data is delivered to a rendering module (step 508), and the rendering module is directed to fill the path data according to a Stencil filling method (step 510). When the changing rate of the path data is less than the threshold (step 506), mesh data of the path data is delivered to the rendering module (step 512), and the rendering module is directed to fill the path data according to a tessellation filling method (step 514). The change rate is then modified according to the path data (step 516). If the filling process is continued (step 518), the steps 502˜516 are repeated again. Otherwise, the filling process ends.

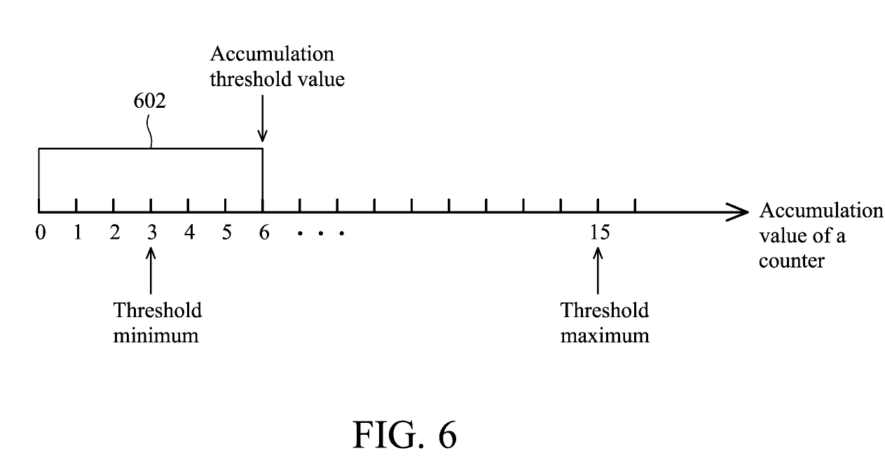

Referring to FIG. 6, a schematic diagram of an embodiment of calculation of a changing rate of path data according to the invention is shown. In one embodiment, the path rendering manager module 304 comprises a counter capable of counting an accumulation value according to a clock signal. When the path data 302 changes, the counter increases the accumulation threshold value according to the clock signal. When the path data 302 changes, the counter resets the accumulation value to zero. A larger accumulation value therefore indicates a lower changing rate, and a smaller accumulation value therefore indicates a higher changing rate. The accumulation value stored in the counter therefore inversely changes with the changing rate of the path data, and the path rendering manager module 304 takes the accumulation value as an inverse estimation value of the changing rate.

The path rendering manager module 304 compares the accumulation of the counter with an accumulation threshold value. When the accumulation value is greater than the accumulation threshold value, the accumulation value does not fall in the region 602, the changing rate of the path data 302 is low, and the path rendering manager module 304 selects the tessellation filling method as the filling method. When the accumulation value is less than the accumulation threshold value, the accumulation value falls in the region 602, the changing rate of the path data 302 is high, and the path rendering manager module 304 selects the Stencil filling method as the filling method. In addition, the path rendering manager module 304 adjusts the accumulation threshold value. In one embodiment, when path data changes, the accumulation threshold value is increased until the accumulation threshold value is equal to a maximum threshold value. When the accumulation value is greater than or equal to the accumulation threshold value, the accumulation threshold value is decreased until the accumulation threshold value is equal to a minimum threshold value.

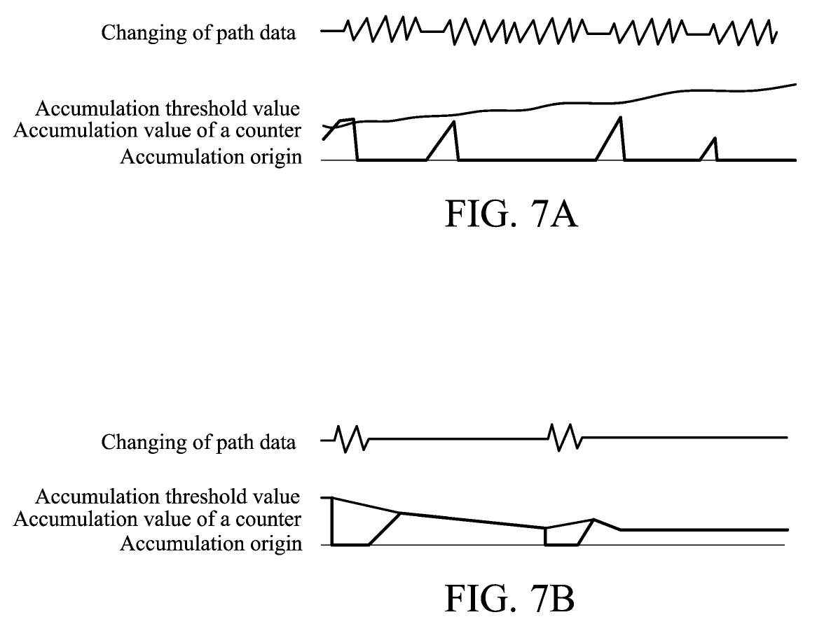

Referring to FIG. 7A, a schematic diagram of an embodiment of filling of animation path data according to the invention. Because the animation path data continues to change, the counter of the path rendering manager module 304 continues to reset the accumulation value stored therein, thus keeping the accumulation value at zero. When the animation path data changes, the path rendering manager module 304 increases the accumulation threshold value, thus keeping the selected filling method as the Stencil filling method. As shown in FIG. 7A, the animation path data only stop changing during four short periods, and the counter increases the accumulation value stored therein during the four short periods. Because the accumulation value is only greater than the accumulation threshold value during the first short period, the rendering module 310 is always directed to fill the animation path data according to a Stencil filling method except for the first short period. The animation path data with a high changing rate is therefore filled according to the Stencil filling method, and efficiency of filling of the animation path data is high, thus improving the performance of the vector graphics system 300.

Referring to FIG. 7B, a schematic diagram of an embodiment of filling of button path data according to the invention. Because the button path data only slightly changes during a few short periods in which a user pushes the button on the screen, the counter of the path rendering manager module 304 continues to increase the accumulation value stored therein until the accumulation value is equal to the accumulation threshold value, thus keeping the selected filling method as the tessellation filling method. When the button path data changes during two short periods, the path rendering manager module 304 resets the accumulation threshold value to zero, and the rendering module 310 is always directed to fill the animation path data according to the tessellation filling method except for the two short periods. The button path data with a low changing rate is therefore filled according to the tessellation filling method, and efficiency of filling of the button path data is high, thus improving the performance of the vector graphics system 300.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A vector graphics system, comprising:
a path rendering manager module, receiving path data, calculating a changing rate of the path data, and selecting a filling method from a tessellation filling method and a Stencil filling method according to the changing rate; and
a rendering module, filling the path data according to the tessellation filling method when the filling method is the tessellation filling method, and filling the path data according to the Stencil filling method when the filling method is the Stencil filling method.

2. The vector graphics system as claimed in claim 1, wherein the path rendering manager module compares the changing rate with a threshold value, and selects the Stencil filling method as the filling method when the changing rate is greater than the threshold value, and selects the tessellation filling method as the filling method when the changing rate is less than the threshold value.

3. The vector graphics system as claimed in claim 1, wherein the path rendering manager module comprises:
a changing rate estimating module, estimating the changing rate of the path data according to feedback statistic information generated by the rendering module; and
a filling method determining module, selecting the filling method from the tessellation filling method and the Stencil filling method according to the changing rate.

4. The vector graphics system as claimed in claim 3, wherein the path rendering manager module further comprises a cost/limitation estimating module for analyzing whether the vector graphics system can provide computational loads required by the tessellation filling method and the Stencil filling method according to system information of the vector graphics system to obtain an analysis result, and the filling method determining module then determines the filling method according to the analysis result.

5. The vector graphics system as claimed in claim 3, wherein the path rendering manager module further comprises a cost/limitation estimating module for analyzing whether the vector graphics system can provide a Stencil buffer bit depth required by the Stencil filling method according to system information of the vector graphics system to obtain an analysis result, and the filling method determining module then determines the filling method according to the analysis result.

6. The vector graphics system as claimed in claim 1, wherein the rendering module further comprises:
a tessellation filling module, filling the path data according to the tessellation filling method when the filling method determined by the path rendering manager module is the tessellation filling method; and
a Stencil filling module, filling the path data according to the Stencil filling method when the filling method determined by the path rendering manager module is the Stencil filling method.

7. The vector graphics system as claimed in claim 6, wherein the vector graphics system further comprises a tessellator, when the filling method is the tessellation filling method, converting a vertex array of the path data to a mesh data for the tessellation filling module.

8. The vector graphics system as claimed in claim 1, wherein the vector graphics system further comprises a counter, increasing an accumulation value stored therein according to a clock signal when the path data does not change, and resetting the accumulation value to zero when the path data does change, thus making the accumulation value change inversely with the changing rate.

9. The vector graphics system as claimed in claim 8, wherein the path rendering manager module compares the accumulation value of the counter with an accumulation threshold value, and selects the tessellation filling method as the filling method when the accumulation value is greater than the accumulation threshold value, and selects the Stencil filling method as the filling method when the accumulation value is less than the accumulation threshold value.

10. The vector graphics system as claimed in claim 9, wherein the path rendering manager module increases the accumulation threshold value according to the clock signal when the path data changes, and the path rendering manager module decreases the accumulation threshold value when the accumulation value is greater than or equal to the accumulation threshold value.

11. The vector graphics system as claimed in claim 1, wherein the path rendering manager module stops increasing the accumulation threshold value when the accumulation threshold value is equal to a maximum threshold value, and stops decreasing the accumulation threshold value when the accumulation threshold value is equal to a minimum threshold value.

12. A vector graphics rendering method, comprising:
receiving path data;
calculating a changing rate of the path data;
comparing the changing rate with a threshold value;
when the changing rate is greater than the threshold value, selecting a Stencil filling method as a filling method;
when the changing rate is less than the threshold value, selecting a tessellation filling method as the filling method; and
filling the path data according to the filling method.

13. The vector graphics rendering method as claimed in claim 12, wherein the changing rate is computed according to feedback statistic information generated during a rendering process for rendering the path data.

14. The vector graphics rendering method as claimed in claim 12, wherein the method further comprises:
analyzing whether the vector graphics system can provide computational loads required by the tessellation filling method and the Stencil filling method according to system information of the vector graphics system to obtain an analysis result; and
determining the filling method according to the analysis result.

15. The vector graphics rendering method as claimed in claim 12, wherein the method further comprises:
analyzing whether the vector graphics system can provide a Stencil buffer bit depth required by the Stencil filling method according to system information of the vector graphics system to obtain an analysis result; and
determining the filling method according to the analysis result.

16. The vector graphics rendering method as claimed in claim 12, wherein the method further comprises when the filling method is the tessellation filling method, converting a vertex array of the path data to mesh data as a basis for filling the path data.

17. The vector graphics rendering method as claimed in claim 12, wherein the method further comprises:
calculating an accumulation value with a counter, wherein the accumulation value changes inversely with the changing rate;
increasing the accumulation value according to a clock signal when the path data does not change; and
resetting the accumulation value to zero when the path data does change.

18. The vector graphics rendering method as claimed in claim 17, wherein the method further comprises:
comparing the accumulation value with an accumulation threshold value;
selecting the tessellation filling method as the filling method when the accumulation value is greater than the accumulation threshold value; and
selecting the Stencil filling method as the filling method when the accumulation value is less than the accumulation threshold value.

19. The vector graphics rendering method as claimed in claim 18, wherein the method further comprises:
increasing the accumulation threshold value according to the clock signal when the path data changes; and
decreasing the accumulation threshold value when the accumulation value is greater than or equal to the accumulation threshold value.

20. The vector graphics rendering method as claimed in claim 19, wherein increasing of the accumulation threshold value is stopped when the accumulation threshold value is equal to a maximum threshold value, and decreasing of the accumulation threshold value is stopped when the accumulation threshold value is equal to a minimum threshold value.
